(19) United States
(12) Patent Application Publication
(10) Pub. No.: US 2023/0399230 A1
(43) Pub. Date: Dec. 14, 2023

(54) METHOD FOR PREPARING IRON PHOSPHATE AND BY-PRODUCT FERTILIZER USING AMMONIUM PHOSPHATE

(71) Applicants: GUIZHOU BATIAN ECOTYPIC ENGINEERING CO., LTD., Guizhou Province (CN); SHENZHEN BATIAN ECOTYPIC ENGINEERING CO., LTD., Guangdong Province (CN)

(72) Inventors: Deming HUANG, Guizhou Province (CN); Guojun ZHAO, Guizhou Province (CN); Faan LIU, Guangdong Province (CN); Jin FANG, Guizhou Province (CN); Shiying HUANG, Guizhou Province (CN); Jing CHENG, Guizhou Province (CN); Lingyun ZHANG, Guizhou Province (CN); Junqiang FENG, Guangdong Province (CN); Jianqing HUA, Guangdong Province (CN)

(21) Appl. No.: 18/209,219

(22) Filed: Jun. 13, 2023

(30) Foreign Application Priority Data
Jun. 13, 2022 (CN) 202210659019.1

(51) Int. Cl. C01B 25/37; C01B 25/234; C05B 17/00; C05G 5/12

(52) U.S. Cl. CPC C01B 25/375; C01B 25/2346; C01P 2006/80; C05G 5/12; C05B 17/00

(57) ABSTRACT

Disclosed is a method for preparing iron phosphate and by-product fertilizer using ammonium phosphate. The granulation device for by-product fertilizer production comprises a housing having accommodation space which is divided from top to bottom into a granulation chamber, a material-screening chamber and a temporary material-storing chamber; a blowing component provided between the granulation chamber and the material-screening chamber; and a vibrating screen which is able to vertically reciprocated provided between the material-screening chamber and the temporary material-storing chamber which is connected to a discharge pipe, wherein the upper end of the housing is provided with a detachable cover having multiple spraying devices for spraying the molten material into the housing and connected to an exhaust pipe. The blowing component comprises multiple staggered and interconnected distribution pipes the upper end of which is connected to multiple blasting pipes and a side of which is connected to an intake pipe.

### Cross-Reference to Related Applications

This application claims priority under 35 U.S.C. § 119(a) to Chinese Patent Application No. 202210659019.1, filed on Jun. 13, 2022, which is hereby incorporated by reference herein in its entirety.

### TECHNICAL FIELD

The present disclosure relates to a technical field of iron phosphate production, and in particular, relates to a method for preparing iron phosphate and by-product fertilizer using ammonium phosphate.

### BACKGROUND ART

During the process of preparing iron phosphate from phosphate concentrate, it requires acidolysis of phosphate concentrate to remove insolubles in acid thereof. However, for the existing acidolysis method, there is a problem of low removal rate of insolubles in acid, and a relatively large amount of residue of insolubles in acid will not only affect the quality of subsequent iron phosphate, but also affect the quality of nitro-phosphorus fertilizer produced from the by-product from iron phosphate production, and it is therefore urgent to develop a method that can effectively improve the removal rate of insolubles in acid from the phosphate concentrate.

### SUMMARY

For the existing problem in the background art, the present disclosure proposes a method for preparing iron phosphate and by-product fertilizer using ammonium phosphate.

The disclosure proposes a method for preparing iron phosphate using ammonium phosphate, comprising the following steps of:
(S11): decomposing phosphorus concentrate with nitric acid, and meanwhile adding a defoamer to defoam during the decomposition process, and following the decomposition, removing insolubles in acid by filtration to obtain a first solution;
(S12): adding sulfuric acid to the first solution in step (S11) for reaction, and following the reaction, performing the filtration to remove calcium sulfate precipitation, to obtain a crude solution of phosphoric acid;
(S13): adding ammonia to the crude solution of phosphoric acid in step (S12) for neutralization reaction, and following the neutralization reaction, performing filtration to obtain a precipitation A and a second solution;
(S14): adding an iron source to the second solution in step (S13) for reaction, and following the reaction, performing the filtration to obtain iron phosphate expressed as a precipitation B and by-product expressed as a third solution.

Preferably, the nitric acid solution in step (S11) has a concentration of 55-65%, and a mass ratio of the nitric acid to the phosphorous concentrate is 1.2-1.4:1.

Preferably, the defoamer in step (S11) consists of polysiloxane, polyoxyvinyl alcohol, polyoxyethylene lauryl ether according to a mass ratio of 1:0.5-1.5:0.5-1.5.

Preferably, the sulfuric acid in step (S12) has a concentration of 98%, and the amount of the sulfuric acid is 90-96% of a theoretical amount of calcium in a frozen mother solution.

Preferably, the amount of the ammonia added in step (S13) is 105-110% of a theoretical amount of ammonia required for forming the ammonium phosphate in the crude solution of phosphoric acid, and the reaction pH is 7-8.

Preferably, the iron source in step (S14) is one or more of iron powder, iron oxide, ferrous oxide or ferric nitrate; the amount of the iron source added is 90-95% of the theoretical amount required for complete reaction with phosphoric acid in the second solution.

The present disclosure proposes a method for preparing fertilizer using by-product from a method for preparing iron phosphate using ammonium phosphate according to the above proposed method, comprising the following steps of: mixing and concentrating the precipitate A in step (S13) and the third solution of the by-product in step (S14) and then melting, and granulating the molten material via a granulation device to obtain nitro-phosphorus fertilizer.

Preferably, the granulation device comprises a housing having an accommodation space which is sequentially divided from top to bottom into a granulation chamber, a material-screening chamber and a temporary material-storing chamber; a blowing component provided between the granulation chamber and the material-screening chamber; and a vibrating screen which is able to vertically reciprocated provided between the material-screening chamber and the temporary material-storing chamber. The temporary material-storing chamber is connected to a discharge pipe, and the upper end of the housing is provided with a detachable end cover and a plurality of spraying devices for spraying the molten material into the housing are provided on the cover, and the end cover is connected to an exhaust pipe.

Preferably, the blowing component comprises a plurality of staggered and interconnected distribution pipes, and the upper end of the distribution pipe is connected to a plurality of blasting pipes, and a side of the distribution pipe is connected to an intake pipe.

Preferably, the lower end of the vibrating screen is connected to a vibrating stretching rod for driving the vibrating screen to reciprocate, and the outer side of the vibrating stretching rod is provided with a stretching isolation sleeve, and two ends of the stretching isolation sleeve are connected to the bottom of the housing and the lower end of the vibrating screen respectively; the stretching isolation sleeve includes a reference sleeve and a sliding sleeve slidingly connected therewith, and a spring is provided between the reference sleeve and the sliding sleeve.

The present disclosure achieves the beneficial technical effect as follows:
(1) In the present disclosure, a defoamer is added to reduce the production of foam during the process of the acidolysis of phosphate concentrate, and the defoamer consisted of polysiloxane, polyoxyvinyl alcohol, polyoxyethylene lauryl ether not only has a certain synergistic effect in defoaming, but also can improve the removal rate of insolubles in acid, thereby ensuring the quality of the subsequent preparation of iron phosphate and nitro-phosphorus fertilizer.
(2) In the present disclosure, the nitro-phosphorus fertilizer is prepared by mixing the phosphate of the impurity metal (expressed as the precipitation A) and the mixed solution of ammonium nitrate and ammonium phosphate produced from the preparation of iron phosphate (expressed as the third solution), which realizes the full reuse of the by-products from the preparation of iron phosphate.
(3) An upward air flow is generated from the blowing component in the granulation device of the present disclosure, and acts on the material in a falling state, which rotates the material in the falling state, and therefore the fertilizer particles are more uniform and the surface is smoother; a vibrating screen provided in the housing enables screening the material to obtain nitro-phosphorus fertilizer that meets the requirements for the particle size.

### BRIEF DESCRIPTION OF DRAWINGS

FIG. 1 is a flowchart of a method for preparing iron phosphate and by-product fertilizer using ammonium phosphate according to one or more embodiments of the present disclosure;

FIG. 2 is a schematic diagram of the structure of a granulation device according to one or more embodiments of the present disclosure;

FIG. 3 is a local magnified view of the section A-A of the granulation device according to one or more embodiments of the present disclosure;

FIG. 4 is a schematic diagram of the structure of a blowing component according to one or more embodiments the present disclosure, wherein:

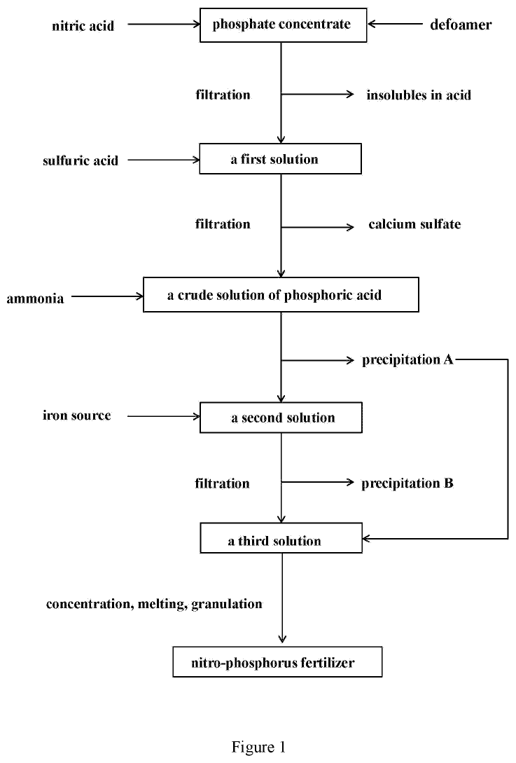

1 is housing, 2 is end cover, 3 is exhaust pipe, 4 is material-spraying device, 5 is granulation chamber, 6 is blowing component, 7 is vibrating screen, 8 is stretching isolation sleeve, 9 is vibrating stretching rod, 10-discharge pipe, 11 is temporary material-storing chamber, 12 is material-screening chamber, 13 is intake pipe, 14 is reference sleeve, 15 is spring, 16 is sliding sleeve, 17is distribution pipe, 18 is blasting pipe.

### DETAILED DESCRIPTION

The composition of phosphate concentrate used in Examples of the present disclosure was determined, and the results were shown in Table 1.

TABLE 1
The composition by weight of the main components in phosphate concentrate

| | | | | | | | | Insolubles | Loss on |
|---|---|---|---|---|---|---|---|---|---|
| Component | P₂O₅ | CaO | MgO | Fe₂O₃ | Al₂O₃ | N | SiO₂ | in acid | ignition |
| Mass ratio | 35.34 | 47.54 | 0.44 | 0.41 | 0.58 | 0.71 | 5.38 | 6.72 | 3.79 |
| (%) | | | | | | | | | |

### EXAMPLE 1

The present disclosure proposes a method for preparing iron phosphate using ammonium phosphate, comprising:

S11: phosphorus concentrate was decomposed with nitric acid, while a defoamer was added to defoam during the decomposition process, and following the decomposition, a filtration was performed to remove insolubles in acid to obtain a first solution; the nitric acid solution had a concentration of 60%, and a mass ratio of nitric acid to the phosphate concentrate was 1.3:1; the defoamer consisted of polysiloxane, polyoxyvinyl alcohol, polyoxyethylene lauryl ether in a mass ratio of 1:1:1, and the amount of the defoamer added was 1% of the mass of phosphate concentrate.

S12: sulfuric acid was added to the first solution in S11 for reaction, and following the reaction, the filtration was performed to remove calcium sulfate precipitation to obtain a crude solution of phosphoric acid; the sulfuric acid had a concentration of 98%, and the amount of the sulfuric acid was 93% of the theoretical amount of calcium in a frozen mother solution.

S13: ammonia was added to the crude solution of phosphoric acid in S12 for neutralization reaction, and following the reaction, filtration was performed to obtain a precipitation A and a second solution; the amount of the ammonia added was 108% of the theoretical amount of ammonia required for forming the ammonium phosphate in the crude solution of phosphoric acid, and the reaction pH was 7.5.

S14: an iron source was added to the second solution in S13 for reaction, and following the reaction, filtration was performed to obtain iron phosphate expressed as a precipitation B and by-product expressed as a third solution; the iron source was ferrous oxide; the amount of the iron source added was 92% of the theoretical amount required for complete reaction with phosphoric acid in the second solution.

### EXAMPLE 2

The present disclosure proposes a method for preparing iron phosphate using ammonium phosphate, comprising:

S11: phosphorus concentrate was decomposed with nitric acid, while the defoamer was added to defoam during the decomposition process, and following the decomposition, the filtration was performed to remove insolubles in acid to obtain a first solution; the nitric acid solution had a concentration of 55%, and the mass ratio of nitric acid to the phosphate concentrate was 1.2:1; the defoamer consisted of polysiloxane, polyoxyvinyl alcohol, polyoxyethylene lauryl ether in a mass ratio of 1:0.5:0.5, and the amount of the defoamer added was 1% of the mass of phosphate concentrate.

S12: sulfuric acid was added to the first solution in S11 for reaction, and following the reaction, the filtration was performed to remove calcium sulfate precipitation to obtain a crude solution of phosphoric acid; the sulfuric acid had a concentration of 98%, and the amount of the sulfuric acid was 90% of the theoretical amount of calcium in the frozen mother solution.

S13: ammonia was added to the crude solution of phosphoric acid in S12 for neutralization reaction, and following the reaction, filtration was performed to obtain a precipitation A and a second solution; the amount of the ammonia added was 105% of the theoretical amount of ammonia required for forming the ammonium phosphate in the crude solution of phosphoric acid, and the reaction pH was 7.

S14: an iron source was added to the second solution in S13 for reaction, and following the reaction, filtration was performed to obtain iron phosphate expressed as a precipitation B and by-product expressed as a third solution; the iron source was ferrous oxide; the amount of the iron source added was 90% of the theoretical amount required for complete reaction with phosphoric acid in the second solution.

### EXAMPLE 3

The present disclosure proposes a method for preparing iron phosphate using

S11: phosphorus concentrate was decomposed with nitric acid, while the defoamer was added to defoam during the decomposition process, and following decomposition, the filtration was performed to remove insolubles in acid to obtain a first solution; the nitric acid solution had a concentration of 65%, and the mass ratio of nitric acid to the phosphate concentrate was 1.4:1; the defoamer consisted of polysiloxane, polyoxyvinyl alcohol, polyoxyethylene lauryl ether in a mass ratio of 1:1.5:1.5, and the amount of the defoamer added was 1% of the mass of phosphate concentrate.

S12: sulfuric acid was added to the first solution in S11 for reaction, and following the reaction, the filtration was performed to remove calcium sulfate precipitation to obtain a crude solution of phosphoric acid; the sulfuric acid had a concentration of 98%, and the amount of the sulfuric acid was 96% of the theoretical amount of calcium in the frozen mother solution.

S13: ammonia was added to the crude solution of phosphoric acid in S12 for neutralization reaction, and following the reaction, filtration was performed to obtain a precipitation A and a second solution; the amount of the ammonia added was 110% of the theoretical amount of ammonia required for forming the ammonium phosphate in the crude solution of phosphoric acid, and the reaction pH was 8.

S14: an iron source was added to the second solution in S13 for reaction, and following the reaction, filtration was performed to obtain iron phosphate expressed as a precipitation B and by-product expressed as a third solution; the iron source was ferrous oxide; the amount of the iron source added was 95% of the theoretical amount required for complete reaction with phosphoric acid in the second solution.

### EXAMPLE 4

The present disclosure proposes a method for preparing fertilizer using by-product from preparing the iron phosphate using ammonium phosphate according to the above proposed method, comprising: the precipitate A in S13 and the third solution of the by-product in S14 were mixed and concentrated and then melted, and the molten material was granulated via a granulation device to obtain nitro-phosphorus fertilizer.

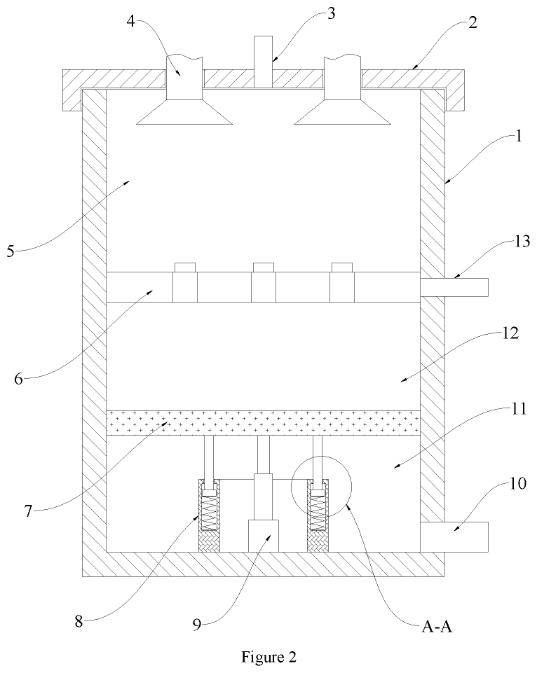

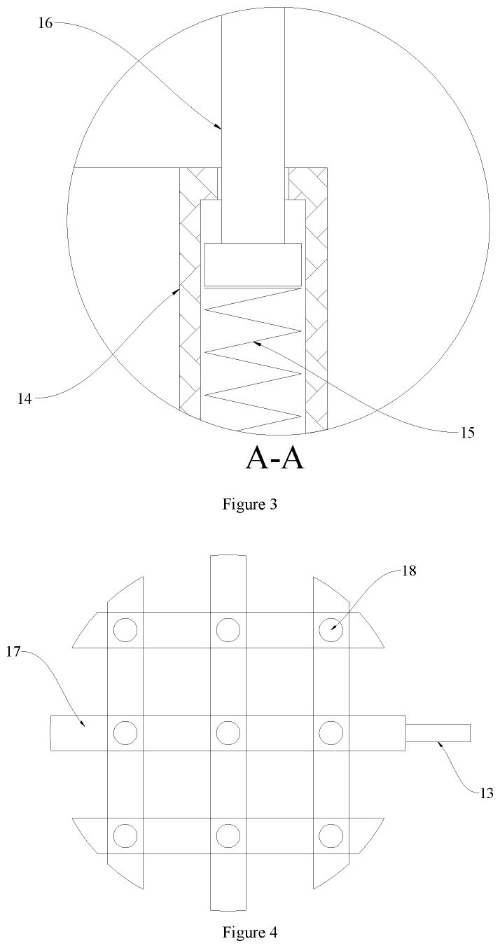

Referring to FIGS. 2-4, the granulation device of the present disclosure comprises a housing 1 having accommodation space which is sequentially divided from top to bottom into a granulation chamber 5, a material-screening chamber 12 and a temporary material-storing chamber 11. A blowing component 6 is provided between the granulation chamber 5 and the material-screening chamber 12, and a vibrating screen 7 which is able to vertically reciprocated is provided between the material-screen chamber 12 and the temporary material-storing chamber 11. The temporary material-storing chamber 11 is connected to a discharge pipe 10, and the upper end of the housing 1 is provided with a detachable end cover 2, and a plurality of spraying devices 4 for spraying the molten material into the housing 1 are provided on the cover 2. For the spraying devices, the atomization of material is achieved by using the existing technology. The end cover 2 is connected to an exhaust pipe 3. Further, the exhaust pipe can be connected to an exhaust gas treatment device to reduce environmental pollution.

Specifically, the blowing component 6 comprises a plurality of staggered and interconnected distribution pipes 17, and the upper end of the distribution pipe 17 is connected to a plurality of blasting pipes 18, and a side of the distribution pipe 17 is connected to an intake pipe 13. The gas introduced to the intake pipe is an inert gas.

Further, the lower end of the vibrating screen 7 is connected to a vibrating stretching rod 9 for driving the vibrating screen 7 to reciprocate, and the outer side of the vibrating stretching rod 9 is provided with a stretching isolation sleeve 8, and the two ends of the stretching isolation sleeve 8 are connected to the bottom of the housing 1 and the lower end of the vibrating screen 7 respectively. The stretching isolation sleeve 8 includes a reference sleeve 14, a sliding sleeve 16 slidingly connected therewith, and a spring 15 provided between the reference sleeve and the sliding sleeve.

An upward air flow is generated from the blowing component 6 in the granulation device of the present disclosure, and acts on the material in a falling state, which rotates the material in the falling state, and therefore the fertilizer particles are more uniform and the surface is smoother. The vibrating screen 7 provided in the housing 1 enables screening the material to obtain nitro-phosphorus fertilizer that meets the requirements for the particle size.

### Comparative Example 1

The present disclosure proposes a method for preparing iron phosphate using ammonium phosphate, comprising:

S11: phosphorus concentrate was decomposed with nitric acid, while the defoamer was added to defoam during the decomposition process, and following decomposition, the filtration was performed to remove insolubles in acid to obtain a first solution; the nitric acid solution had a concentration of 60%, and the mass ratio of nitric acid to the phosphate concentrate was 1.3:1; the defoamer consisted of polysiloxane, polyoxyvinyl alcohol in a mass ratio of 1:1, and the amount of the defoamer added was 1% of the mass of phosphate concentrate.

S12: sulfuric acid was added to the first solution in S11 for reaction, and following the reaction, the filtration was performed to remove calcium sulfate precipitation to obtain a crude solution of phosphoric acid; the sulfuric acid had a concentration of 98%, and the amount of the sulfuric acid was 93% of the theoretical amount of calcium in the frozen mother solution.

S13: ammonia was added to the crude solution of phosphoric acid in S12 for neutralization reaction, and following the reaction, filtration was performed to obtain a precipitation A and a second solution; the amount of the ammonia added was 108% of the theoretical amount of ammonia required for forming the ammonium phosphate in the crude solution of phosphoric acid, and the reaction pH was 7.5.

S14: an iron source was added to the second solution in S13 for reaction, and following the reaction, filtration was performed to obtain iron phosphate expressed as a precipitation B and by-product expressed as a third solution; the iron source was ferrous oxide; the amount of the iron source added was 92% of the theoretical amount required for complete reaction with phosphoric acid in the second solution.

### Comparative Example 2

The present disclosure proposes a method for preparing iron phosphate using

S11: phosphorus concentrate was decomposed with nitric acid, while the defoamer was added to defoam during the decomposition process, and following decomposition, the filtration was performed to remove insolubles in acid to obtain a first solution; the nitric acid solution had a concentration of 60%, and the mass ratio of nitric acid to the phosphate concentrate was 1.3:1; the defoamer consisted of polysiloxane, polyoxyethylene lauryl ether in a mass ratio of 1:1, and the amount of the defoamer added was 1% of the mass of phosphate concentrate.

S12: sulfuric acid was added to the first solution in S11 for reaction, and following the reaction, the filtration was performed to remove calcium sulfate precipitation to obtain a crude solution of phosphoric acid; the sulfuric acid had a concentration of 98%, and the amount of the sulfuric acid was 93% of the theoretical amount of calcium in the frozen mother solution.

S13: ammonia was added to the crude solution of phosphoric acid in S12 for neutralization reaction, and following the reaction, filtration was performed to obtain a precipitation A and a second solution; the amount of the ammonia added was 108% of the theoretical amount of ammonia required for forming the ammonium phosphate in the crude solution of phosphoric acid, and the reaction pH was 7.5.

S14: an iron source was added to the second solution in S13 for reaction, and following the reaction, filtration was performed to obtain iron phosphate expressed as a precipitation B and by-product expressed as a third solution; the iron source was ferrous oxide; the amount of the iron source added was 92% of the theoretical amount required for complete reaction with phosphoric acid in the second solution.

### Comparative Example 3

The present disclosure proposes a method for preparing iron phosphate using ammonium phosphate, comprising:

S11: phosphorus concentrate was decomposed with nitric acid, while the defoamer was added to defoam during the decomposition process, and following decomposition, the filtration was performed to remove insolubles in acid to obtain a first solution; the nitric acid solution had a concentration of 60%, and the mass ratio of nitric acid to the phosphate concentrate was 1.3:1; the defoamer consisted of polyoxyvinyl alcohol, polyoxyethylene lauryl ether in a mass ratio of 1:1, and the amount of the defoamer added was 1% of the mass of phosphate concentrate.

S12: sulfuric acid was added to the first solution in S11 for reaction, and following the reaction, the filtration was performed to remove calcium sulfate precipitation to obtain a crude solution of phosphoric acid; the sulfuric acid had a concentration of 98%, and the amount of the sulfuric acid was 93% of the theoretical amount of calcium in the frozen mother solution.

S13: ammonia was added to the crude solution of phosphoric acid in S12 for neutralization reaction, and following the reaction, filtration was performed to obtain a precipitation A and a second solution; the amount of the ammonia added was 108% of the theoretical amount of ammonia required for forming the ammonium phosphate in the crude solution of phosphoric acid, and the reaction pH was 7.5.

S14: an iron source was added to the second solution in S13 for reaction, and following the reaction, filtration was performed to obtain iron phosphate expressed as a precipitation B and by-product expressed as a third solution; the iron source was ferrous oxide; the amount of the iron source added was 92% of the theoretical amount required for complete reaction with phosphoric acid in the second solution.

### Comparative Example 4

The present disclosure proposes a method for preparing iron phosphate using ammonium phosphate, comprising:

S11: phosphorus concentrate was decomposed with nitric acid, and following decomposition, the filtration was performed to remove insolubles in acid to obtain a first solution; the nitric acid solution had a concentration of 60%, and the mass ratio of nitric acid to the phosphate concentrate was 1.3:1.

S12: sulfuric acid was added to the first solution in S11 for reaction, and following the reaction, the filtration was performed to remove calcium sulfate precipitation to obtain a crude solution of phosphoric acid; the sulfuric acid had a concentration of 98%, and the amount of the sulfuric acid was 93% of the theoretical amount of calcium in the frozen mother solution.

S13: ammonia was added to the crude solution of phosphoric acid in S12 for neutralization reaction, and following the reaction, filtration was performed to obtain a precipitation A and a second solution; the amount of the ammonia added was 108% of the theoretical amount of ammonia required for forming the ammonium phosphate in the crude solution of phosphoric acid, and the reaction pH was 7.5.

S14: an iron source was added to the second solution in S13 for reaction, and following the reaction, filtration was performed to obtain iron phosphate expressed as a precipitation B and by-product expressed as a third solution; the iron source was ferrous oxide; the amount of the iron source added was 92% of the theoretical amount required for complete reaction with phosphoric acid in the second solution.

It can be seen from the test results of Example 1 and Comparative Examples 1-3 that the defoaming effect of the defoamer used in Example 1 was significantly superior to the defoaming effect of Comparative Examples 1-3, which indicated that the defoamer of the present disclosure had a certain synergistic effect in defoaming during the acidolysis process.

In addition, it was determined that, following the acidolysis of 1000 g phosphate concentrate using the scheme in Example 1, the mass of insolubles in acid was 68.71 g, and following the acidolysis using the scheme in Comparative Example 4, the mass of insoluble in acid is up to 87.48 g, which indicated that the defoamer added in the present disclosure not only functioned as defoaming, but also can improve the removal rate of insolubles in acid, thereby ensuring the quality of the subsequent preparation of iron phosphate and nitro-phosphorus fertilizer.

The above merely describes specific embodiments of the present disclosure and is not intend to limit the scope of the present disclosure. Any variants and modifications made within the spirit and principle of the present disclosure should be included in the protection scope of the present disclosure.

1. A method for preparing iron phosphate using ammonium phosphate, comprising the steps of:
(S11) decomposing phosphorus concentrate with nitric acid, and meanwhile adding a defoamer to defoam during the decomposition process, and following the decomposition, removing insolubles in acid by filtration to obtain a first solution;
(S12) adding sulfuric acid to the first solution in step (S11) for reaction, and following the reaction, performing the filtration to remove calcium sulfate precipitation, to obtain a crude solution of phosphoric acid;
(S13) adding ammonia to the crude solution of phosphoric acid in step (S12) for neutralization reaction, and following the neutralization reaction, performing filtration to obtain a precipitation A and a second solution;
(S14) adding an iron source to the second solution in step (S13) for reaction, and following the reaction, performing the filtration to obtain iron phosphate expressed as a precipitation B and by-product expressed as a third solution.

2. The method for preparing iron phosphate using ammonium phosphate according to claim 1, wherein the nitric acid solution in step (S11) has a concentration of 55-65%, and a mass ratio of the nitric acid to the phosphorous concentrate is 1.2-1.4:1.

3. The method for preparing iron phosphate using ammonium phosphate according to claim 1, wherein the defoamer in step (S11) consists of polysiloxane, poly oxyvinyl alcohol, polyoxyethylene lauryl ether in a mass ratio of 1:0.5-1.5:0.5-1.5.

4. The method for preparing iron phosphate using ammonium phosphate according to claim 1, wherein the sulfuric acid in step (S12) has a concentration of 98%, and the amount of the sulfuric acid is 90-96% of a theoretical amount of calcium in a frozen mother solution.

5. The method for preparing iron phosphate using ammonium phosphate according to claim 1, wherein the amount of the ammonia added in step (S13) is 105-110% of a theoretical amount of ammonia required for forming the ammonium phosphate in the crude solution of phosphoric acid, and the reaction pH is 7-8.

6. The method for preparing iron phosphate using ammonium phosphate according to claim 1, wherein the iron source in step (S14) is one or more of iron powder, iron oxide, ferrous oxide or ferric nitrate; and wherein the amount of the iron source added is 90-95% of the theoretical amount required for complete reaction with phosphoric acid in the second solution.

7. A method for preparing fertilizer using by-product from a method for preparing iron phosphate using ammonium phosphate according to claim 1, comprising the following steps of: mixing and concentrating the precipitate A in step (S13) and the third solution of the by-product in step (S14) and then melting, and granulating the molten material via a granulation device to obtain nitro-phosphorus fertilizer.

8. The method according to claim 7, wherein the granulation device comprises a housing having accommodation space which is sequentially divided from top to bottom into a granulation chamber, a material-screening chamber and a temporary material-storing chamber; a blowing component provided between the granulation chamber and the material-screening chamber; a vibrating screen which is able to vertically reciprocated provided between the material-screen chamber and the temporary material-storing chamber, wherein the temporary material-storing chamber is connected to a discharge pipe, and wherein the upper end of the housing is provided with a detachable end cover and a plurality of spraying devices for spraying the molten material into the housing are provided on the end cover, and the cover is connected to an exhaust pipe.

9. The method according to claim 8, wherein the blowing component comprises a plurality of staggered and interconnected distribution pipes, and the upper end of the distribution pipe is connected to a plurality of blasting pipes, and a side of the distribution pipe is connected to an intake pipe.

10. The method according to claim 8, wherein the lower end of the vibrating screen is connected to a vibrating stretching rod for driving the vibrating screen to reciprocate, and the outer side of the vibrating stretching rod is provided with a stretching isolation sleeve, and two ends of the stretching isolation sleeve are connected to the bottom of the housing and the lower end of the vibrating screen respectively; and wherein the stretching isolation sleeve includes a reference sleeve, a sliding sleeve slidingly connected therewith, and a spring provided between the reference sleeve and the sliding sleeve.
